(19) United States
(12) Patent Application Publication
(10) Pub. No.: US 2015/0023008 A1
(43) Pub. Date: Jan. 22, 2015

(54) Adjustable Safety Light Attachment for Various Sized Handles

(71) Applicants: Stephen Lee Milionis, Spokane, WA (US); Scott James Milionis, Spokane, WA (US)

(72) Inventors: Stephen Lee Milionis, Spokane, WA (US); Scott James Milionis, Spokane, WA (US)

(21) Appl. No.: 13/947,076

(22) Filed: Jul. 21, 2013

(51) Int. Cl. F21V 21/08; F21L 4/02; F21V 33/00; F21L 4/08

(52) U.S. Cl. CPC F21V 21/08; F21L 4/08; F21L 4/027; F21V 21/0816; F21V 33/0084
USPC 362/183; 362/184

(57) ABSTRACT

An adjustable safety light attachment with an opening that can be adjusted in size and shape to fit various sizes and patterns of handles for any tool. The adjustable safety light attachment has a hollow housing with a front portion that is held together to a back portion using a hinge, so that the front portion can swivel with respect to the back portion. The front portion and back portion are also held together and locked in a closed position using at least one strap. Adjustable inserts are inserted inside the housing and can be changed to control the opening of the hollow housing. A circuit board containing control circuitry is powered using a power source, with both being disposed on the hollow housing. The control circuitry is used to control a plurality of lights disposed in various places on the hollow housing.

### BACKGROUND OF THE INVENTION

1. Field of the Invention

The present invention relates generally to safety hazard lights. More particularly, the present invention relates to an adjustable safety light attachment that fits various sized handles to provide illumination in hazardous situations.

2. Background Art

Hand tools are used in a variety of environments including construction sites, roadwork, at home projects, and any other environment where work needs to be accomplished. Problems can occur though when these hand tools are being used in environments that do not include proper lighting, such as at night or in areas of thick fog. These low lighting environments can cause safety problems to the workers using the various hand tools, such as pedestrian drivers not being able to see the worker in time to stop. Some solutions have been developed to improve the safety for workers in these environments, including light assemblies built into the tools being worked with. However, these solutions still have many problems when it comes to the safety of the worker using the hand tool. The main problem that still exists with light assemblies being built into the tool is that they are not adaptable to other tools that a worker may need to use, such as when a worker decides to go from a broom to a shovel.

Accordingly, there is a need to overcome the deficiencies in the art by providing an adjustable safety light attachment that can fit various sized and shaped handles on different working tools.

### SUMMARY OF THE INVENTION

There is provided an adjustable safety light attachment for providing protection to users of various hand tools during hazardous conditions, substantially as shown in and/or described in connection with at least one of the figures, and as set forth more completely in the claims.

### BRIEF DESCRIPTION OF THE DRAWINGS

FIG. 1 illustrates a perspective view of the outside of the adjustable safety light attachment, according to an embodiment of the present invention.

FIG. 2 illustrate a perspective view of the inside of the adjustable safety light attachment, according to an embodiment of the present invention.

FIG. 3 illustrates a bottom view of the adjustable safety light attachment, according to an embodiment of the present invention.

FIG. 4 illustrates a top view of the adjustable safety light attachment, according to an embodiment of the present invention.

FIG. 5A illustrates an adjustable insert for circular handle tools, according to an embodiment of the present invention.

FIG. 5B illustrates an adjustable insert for square handle tools, according to an embodiment of the present invention.

FIG. 6 illustrates a perspective view of the straps closing the adjustable safety handle light, according to an embodiment of the present invention.

FIG. 7 illustrates a perspective view of the adjustable safety light attachment secured to a shovel hand tool, according to an embodiment of the present invention.

FIG. 8 illustrates a perspective view of the control circuitry, according to an embodiment of the invention.

FIG. 9 illustrates an example of the inside electrical connections for the adjustable safety light attachment, according to an embodiment of the present invention.

### DETAILED DESCRIPTION OF THE INVENTION

The present application is directed to an adjustable safety light attachment for providing protection to users of various hand tools during hazardous conditions. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

Reference is made herein to the attached drawings. Like reference numerals are used throughout the drawings to depict like or similar elements of the adjustable safety hazard light attachment. For the purpose of presenting a brief and clear description of the present invention, the preferred embodiment will be discussed as for providing nighttime or low-light illumination and hazard warning in work or sporting environments. To maintain brevity, other embodiments of the invention, which use the principles of the present invention, are not specifically described in the present application and are not specifically illustrated by the present drawings.

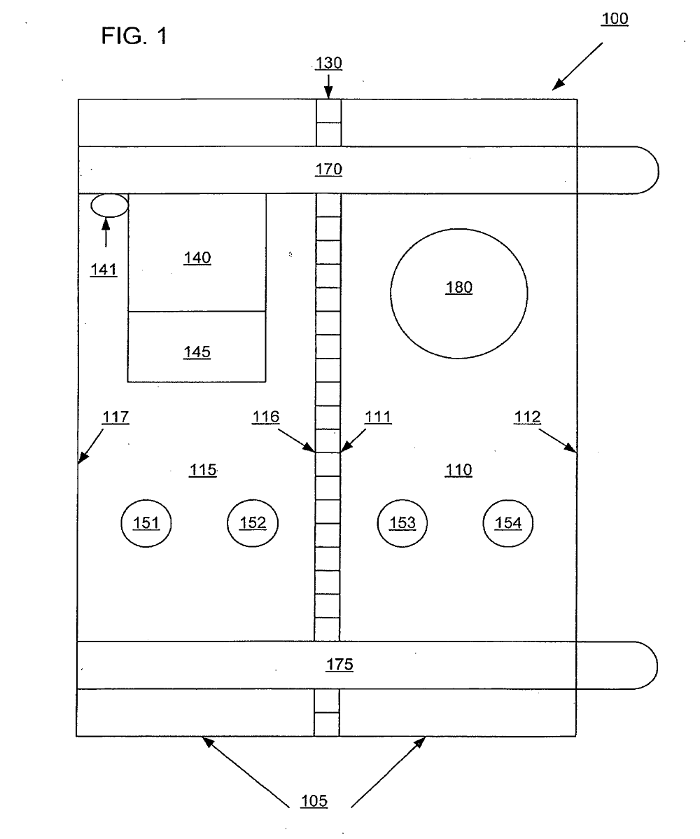

FIG. 1 illustrates an outside perspective view of an adjustable safety light attachment, according to the preferred embodiment of the invention. Adjustable safety light attachment 100 of FIG. 1 includes hollow housing 105, hinge 130, power source casing 140, power source outlet 141, control circuitry 145, lights 151-154, strap 170, strap 175, and flashlight 180. Hollow housing 105 comprises a front portion 110 and a back portion 115. First portion 110 includes a first side 111 and a second side 112. Back portion 115 includes a first side 116 and a second side 117.

According to the preferred embodiment of FIG. 1, the hollow housing 105 comprises two distinct portions, the front portion 110 and the back portion 115. The front portion 110 is attached to the back portion 115 using the hinge 130, which attaches to the first side 111 of the front portion 110 and to the first side 116 of the back portion 115. By using the hinge 130 to attach the front portion 110 to the back portion 115, the front portion 110 can swivel with respect to the back portion 115, thus opening and closing of the hollow housing 105 can take place. Furthermore, as described in more detail below, when the hollow housing 105 is in the closed position, straps 170 and 175 attach the second side 112 of front portion 110 to the second side 117 of the back portion 115, thus, locking the hollow housing 105 in a locked position.

The hollow housing 105 of the adjustable safety light attachment 100 is not limited to the embodiment of FIG. 1. In another embodiment, the first side 111 of the front portion 110 may be attached to the first side 116 of the back portion 115 using screws or straps. In such embodiments, the front portion 110 would still be able to swivel with respect to the back portion 115, so that the hollow housing 105 can open and close. In another embodiment, the hollow housing 105 may not comprise two distinct portions, but may comprise one solid portion. Still in other embodiments, the hollow housing 105 may comprise of more than two portions, with each being attached by an attaching means such as a hinge.

The hollow housing 105 may be constructed out of various materials. In the preferred embodiment, the hollow housing 105 is constructed out of a hard and durable material, such as plastic or some sort of metal. However, in other embodiments, the hollow housing 105 can be constructed of any other material that is known in the art. Furthermore, the hollow housing 105 may be constructed using any color, such as, but not limited to black, red or yellow.

The preferred embodiment of FIG. 1 further illustrates lights 151-154 disposed on the hollow housing 105. As illustrated in FIG. 1, two lights 151 and 152 are attached to the back portion 115, and two lights 153 and 154 are attached to the front portion 110. However, the embodiment illustrated in FIG. 1 is not limiting. For example, in other embodiments, more or less lights may disposed on the hollow housing 105. Furthermore, in other embodiments, the lights may be disposed in different positions of the hollow housing 105, such as on the top or middle of the hollow housing. Also, the lights may be disposed in different numbers on the first portion 110 and the second portion 115. For example, the first portion 110 may include four lights while the second portion 115 includes two lights.

The lights 151-154 according to the preferred embodiment of FIG. 1 may be Light Emitting Diodes (LEDs) and include different colors and various cycles of illumination patterns. For example, the lights 151-154 may each be red, blue, white, clear, yellow or any other color LEDs. Furthermore, the lights 151-154 may not include the same color, but include various combinations of colors. For example, lights 151 and 153 may each comprise a red color, while lights 152 and 154 each comprise a yellow color. Furthermore, as discussed in more detail below, the lights 151-154 may include various cycles of illumination patterns. For example, according to one embodiment, the lights 151-154 may include a solid cycle so they are constantly on, a fast flashing cycle, a slow flashing cycle, a rotational cycle, and an off cycle.

In the preferred embodiment, lights 151-154 are electrically connected to a circuit board and illumination of the lights 151-154 is controlled by the control circuitry 145 included on the circuit board, which is discussed in more detail below. In the embodiment of FIG. 1, the circuit board is powered by a power source disposed in the power source casing 140, which may be a battery. The battery used as the power source and disposed in the power source casing 140 may be any conventional battery technology such as, for example, lithium ion, nick-metal-hydride, nickel-cadmium, or alkaline. The battery may be rechargeable using the power source outlet 141 or the battery may be disposable. Furthermore, the battery may be comprised of more than one battery depending on voltage requirements.

Also shown in the preferred embodiment of FIG. 1 is flashlight 180. Flashlight 180 is disposed on the hollow housing 105 and may be used so that a person using the adjustable safety light attachment 100 can better see the environment being worked on. The flashlight 180 is electrically connected to the circuit board and is controlled using the control circuitry 145. In the preferred embodiment, the flashlight 180 uses a regular light bulb and has control cycles of illumination of on and off. The flashlight 180 can be adjustable, so that the angle of the light can be pointed towards the specific area being worked on.

In other embodiments, the flashlight 180 may consist of various colors, such as red, blue, white, or green. Furthermore, in other embodiments, the flashlight 180 may include other cycles of illumination, such as a quick flashing cycle or a slow flashing cycle. However, the flashlight is not limited to the colors and cycles of illumination described above and may include any color or cycle of illumination known in the art.

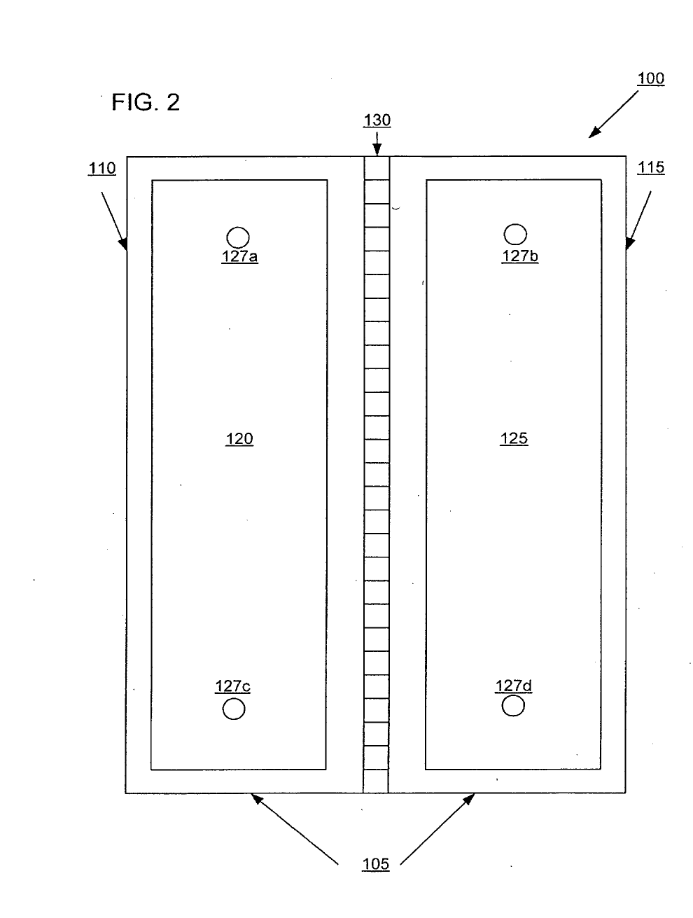

FIG. 2 illustrates an inside perspective view of the adjustable safety light attachment, according to the preferred embodiment of the invention. Adjustable safety light attachment 100 of FIG. 2 includes hollow housing 105, adjustable insert 120, adjustable insert 125, screws 127a-127d, and hinge 130. The hollow housing 105 includes the front portion 110 and the back portion 115. As shown in the embodiment of FIG. 2, the adjustable safety light attachment 100 is in the open position with the inside of the hollow housing 105 illustrated. Just like in FIG. 1, the front portion 110 and the back portion 115 of the hollow housing 105 are being held together using the hinge 130.

Illustrated in the preferred embodiment of FIG. 2 are adjustable inserts 120 and 125, which attach to the front portion 110 and the back portion 115, respectively. The adjustable inserts 120 and 125 are inserted and attached to the inside of the hollow housing 105 so that an opening (not shown) of the hollow housing 105 can be adjusted. In this way, the adjustable inserts 120 and 125 can come in a variety of shapes and sizes so that the adjustable safety light attachment 100 can fit around any sized handle of any tool. For example, the adjustable inserts 120 and 125 may include various thicknesses, so that the opening of the hollow housing 105 increases or decreases in size. Furthermore, the adjustable inserts 120 and 125 may come in different shapes, so that the opening of the hollow housing can fit around a square handle, a circular handle, a triangular handle, or any other shaped handle for any tool.

As shown in the preferred embodiment of FIG. 2, the adjustable safety light attachment 100 includes two adjustable inserts, adjustable inserts 120 and 125. However, in other embodiments, the adjustable safety light attachment 100 may include only one insert that is attached to both the front portion 110 and the back portion 115. Furthermore, in other embodiments, the adjustable safety light attachment 100 may include any number of adjustable inserts arranged inside and attached to the front portion 110 and the back portion 115 in a number of ways. For example, each of the front portion 110 and the back portion 115 may include two or three inserts, or the front portion 110 may include one adjustable insert while the back portion 115 includes two adjustable inserts. Furthermore, in alternative embodiments, adjustable insert 120 may be a different shape or size than adjustable insert 125.

In the preferred embodiment of FIG. 2, the adjustable inserts 120 and 125 are constructed of rubber or a rubber like material. However, in other embodiments, the adjustable inserts 120 and 125 may be constructed out of a different material, such as a cloth, like cotton, or a plastic material. Furthermore, the adjustable inserts may include an adhesive or other sticky like material applied to the outer portions so that the adjustable safety light attachment 100 is more secure to the handle and does not slide along the handle while being attached. However, the material of the adjustable inserts 120 and 125 is not limited to the materials listed above and may be constructed of any other material known in the art.

Further illustrated in FIG. 2 are screws 127a-127d. As shown in the embodiment of FIG. 2, screws 127a and 127c are used to attach the adjustable insert 120 to the front portion 110, while screws 127b and 127d are used to attach the adjustable insert 125 to the back portion 115. However, in other embodiments, adjustable inserts 120 and 125 may be attached to the front portion 110 and the back portion 115 using other methods, such as straps, Velcro, clips, or an adhesive. Still in other embodiments, adjustable inserts 120 and 125 may be attached using any other method known in the art.

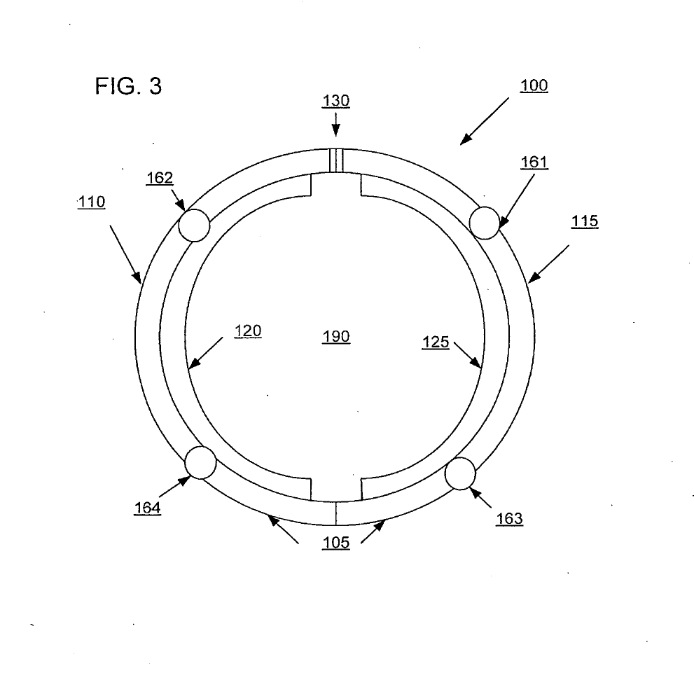

FIG. 3 illustrates a perspective view of the bottom of the adjustable safety light attachment in a closed position, according to the preferred embodiment of the invention. Adjustable safety light attachment 100 of FIG. 3 includes hollow housing 105, adjustable insert 120, adjustable insert 125, hinge 130, and lights 161-164. The hollow housing 105 comprises front portion 110 and back portion 115. Also shown in FIG. 3 is opening 190, which is created inside the hollow housing 105 when the adjustable safety light attachment 100 is in a closed position.

As illustrated in FIG. 3, adjustable inserts 120 and 125 are inserted and attached within the opening 190 of the hollow housing 105. As described above, the adjustable inserts 120 and 125 may take various shapes and sizes so as to adjust the opening 190 to securely fit around any sized handle. In the embodiment shown in FIG. 3, adjustable inserts 120 and 125 are shaped so that the opening 190 takes a shape of and can fit around a circle handle. However, as discussed above, adjustable inserts may also be shaped so that the opening 190 takes a shape of a square, a triangle or any other shape a handle might include.

As further illustrated in the preferred embodiment of FIG. 3, the outside of the hollow housing 105 takes the shape of a circle. However, the adjustable safety light attachment is not limited to the hollow housing 105 comprising the shape of a circle. In other embodiments, the hollow housing 105 may take the shape of a square, a triangle, a pentagon, a hexagon, etc. Furthermore, in other embodiments, the outside of the hollow housing 105 may not be uniform in shape and may include any other shape known in the art.

Further illustrated in the preferred embodiment of FIG. 3 are lights 161-164 disposed on the bottom of the hollow housing 105. In the preferred embodiment, lights 161-164 are clear LED lights. Also, in the preferred embodiment, the lights 161-164 are electrically connected to the circuit board (not shown) and controlled using the controls of the control circuitry 145. Furthermore, like lights 151-154 discussed above, the lights 161-164 may come in various colors and include various cycles of illumination patterns.

As shown in the preferred embodiment of FIG. 3, the hollow housing 105 includes four lights 161-164, two lights 162 and 164 disposed on the front portion 110, and two lights 161 and 163 disposed on the back portion 115. However, in other embodiments, the bottom of the adjustable safety light attachment may include more or less lights. For example, each of the front portion 110 and the back portion 115 may include one light. In another example, the front portion 110 may include one light while the back portion 115 may include three lights.

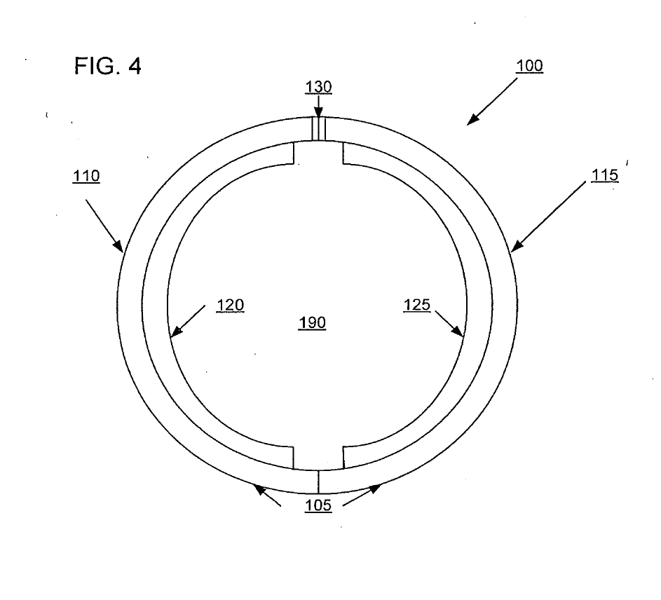

FIG. 4 illustrates a perspective view of the top of the adjustable safety light attachment while in the closed position, according to the preferred embodiment of the invention. Adjustable safety light attachment 100 of FIG. 4 includes hollow housing 105, adjustable insert 120, adjustable insert 125, and hinge 130. The hollow housing 105 comprises front portion 110 and back portion 115. Also shown in FIG. 3 is opening 190 of the inside of the hollow housing 105.

As illustrated in the preferred embodiment of FIG. 4, the top of the adjustable safety light attachment 100 includes no lights. However, in other embodiments, the top of the adjustable safety light attachment 100 may include any number of lights disposed on the hollow housing 105. For example, the top of the hollow housing 105 may include four white LED lights, or two red LED lights and two white LED lights. Furthermore, as stated above with regards to lights 151-154 and lights 161-164, the lights disposed on the top the hollow housing 105 may be electrically connected to the circuit board and controlled by the control circuitry 145. Furthermore, lights attached to the top of the adjustable safety light attachment 100 may comprise various colors and cycles of illumination.

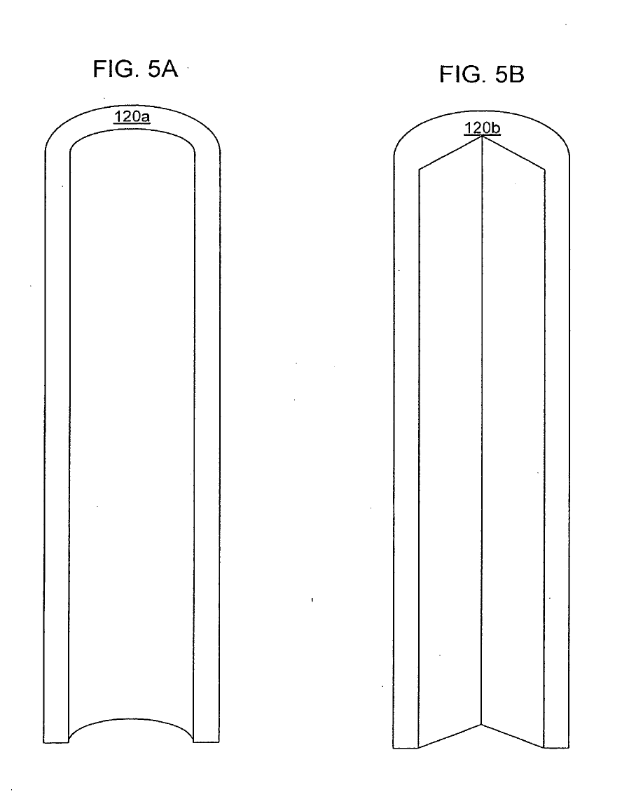

FIGS. 5A and 5B illustrate different shapes for the adjustable inserts. FIG. 5A illustrates an adjustable insert 120a that may be attached within the hollow housing 105 so that the opening 190 fits a circular hand tool. FIG. 5B illustrates an adjustable insert 120b that may be attached within the hollow housing 105 so that the opening 190 fits a square hand tool. Each of adjustable insert 120a and adjustable insert 120b may be attached to the front portion 110 and/or the back portion 115 of the hollow housing 105 as adjustable inserts 120 and 125. Furthermore, as discussed above, other shaped adjustable inserts may be used than just those illustrated in FIGS. 5A and 5B.

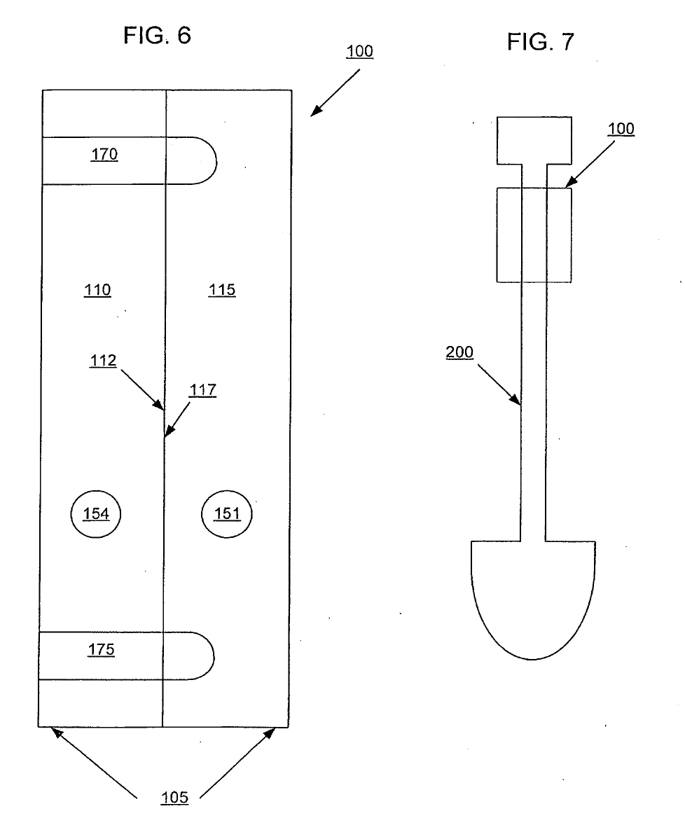

FIG. 6 illustrates a perspective view of the straps closing and locking the adjustable safety light attachment, according to the preferred embodiment of the invention. Adjustable safety light attachment 100 includes hollow housing 105, light 151, light 154, strap 170, and strap 175. The hollow housing 105 comprises front portion 110 and back portion 115. The front portion 110 includes second side 112 and the back portion 115 includes second side 117.

As illustrated in the preferred embodiment of FIG. 6, when the adjustable hollow housing 105 is in a closed position, the second side 112 of the front portion 110 contacts the second side 117 of the back portion 115. To lock the hollow housing 105 in the closed position, straps 170 and 175 are used to strap the back portion 115 to the front portion 110. In the preferred embodiment of FIG. 6, straps 170 and 175 are permanently disposed on the front portion 110 and attach to the back portion 115 by an attaching means. For example, straps 170 and 175 may both comprise Velcro straps so that a worker can adjust how tightly to secure the hollow housing 105 to the handle of the tool being worked with. In other embodiments, the straps 170 and 175 may be clips or an adhesive to help secure the front portion 110 to the back portion 115 of the hollow housing 105. However, still in other embodiments, any type of strap known in the art may be used to attach the front portion 110 to the back portion 115.

As shown in FIG. 6, two straps 170 and 175 are used to attach and lock the front portion 110 to the back portion 115 when the hollow housing 105 is in the locked position. However, this embodiment is not limiting. In other embodiments, more or less straps may be used in various positions to close and lock the hollow housing 105. For example, one thick Velcro strap may be placed in the middle of the hollow housing 105 to secure the adjustable safety light attachment 100 in the locked position. In another example, three or four straps using clips may be used to secure the adjustable safety light attachment 100 in the closed and locked position.

FIG. 7 illustrates a perspective view of the adjustable safety light attachment 100 secured to the handle of a tool, according to the preferred embodiment. As illustrated in FIG. 7, the adjustable safety light attachment 100 is secured to the top portion of a shovel 200. However, the adjustable safety light attachment 100 may be placed and attached to any part of the handle of the shovel. For example, the adjustable safety light attachment 100 may be attached to the middle or bottom part of the handle of the shovel 200.

The embodiment of FIG. 7 only shows the adjustable safety light attachment 100 attached to the handle of a shovel 200, but this is not limiting. The adjustable safety light attachment 100 may also be attached to any other tool that a worker might be working with, which includes a handle. These tools may include, but are not limited to, a broom, a rake, a hammer, or any other construction tools with handles known in the art. Furthermore, the adjustable safety light attachment 100 is not just limited to construction tools and may be used in any environment where light is needed and something with a handle is being used. For example, the adjustable safety light attachment 100 may be used in sports, such as attached to a ski pole or a walking stick. Furthermore, the adjustable safety light attachment 100 may be attached to the handle of an umbrella during low light situations because of weather. Also, the adjustable safety light attachment 100 does not require that there be a handle to attach to in order to be helpful. It may also be used by a person just carrying it around in low light environments, when safety is an issue and light is needed.

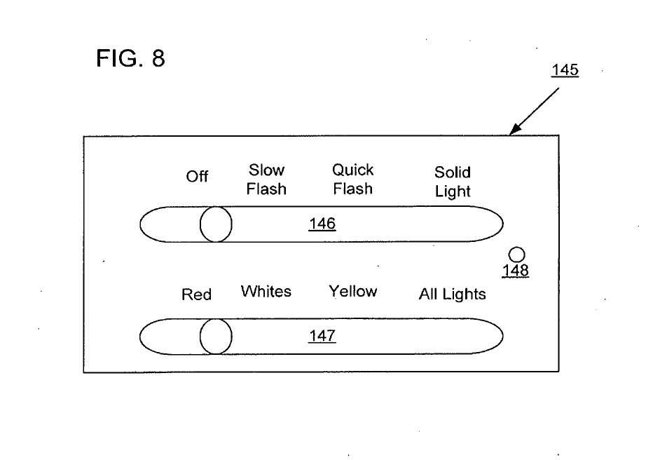

FIG. 8 illustrates control circuitry included on the circuit board, according to the preferred embodiment of the invention. Power supplied by the power source in the power source casing 140 (not shown) is toggled on and off using the cycle switch 146. When power flows through the control circuitry, the lights disposed on the hollow housing 105 are illuminated according to the present cycle of illumination patter, which is selected using cycle switch 146. In the preferred embodiment of FIG. 8, four different cycles of illumination patterns are shown and include off, slow flash, quick flash, and solid light. However, it should be understood that the described cycles of illumination for the control circuitry 145 is for preferred purposes only and it is not intended to limit the construction of the adjustable safety light attachment 100 to this specific electrical configuration. Using a switch to control electrical circuits is known in the art of circuitry and one of ordinary skill in the art would be able to adapt other configurations of circuitry for the cycles of illumination patterns.

Also illustrated in FIG. 8 is light selection switch 147. As described above, the plurality of lights attached to the hollow housing 105 and electrically connected to the circuit board may come in various colors and be disposed in various positions throughout the hollow housing 105. The light selection switch 147 can therefore be used to select the present color of lights to be turned on when cycle switch 146 is selecting one of the cycles of illumination patterns. FIG. 8 shows that the light selection switch 147 has four different selections including red lights, white lights, yellow lights, and all lights. However, it should be understood that the described selections for the light selection switch 147 is for preferred purposes only and it is not intended to limit the construction of the adjustable safety light attachment 100 to this specific configuration. For example, more selections with different color options may be provided, or different color patterns may be provided.

It should be understood that the control circuitry 145 discussed above using the cycle switch 146 and the light selection switch 147 is just illustrated as a preferred embodiment and the invention is not intended to be limited to just the embodiment shown. For example, in other embodiments, the control circuitry 145 might be adjusted using voice activated controls or some type of magnet placed in close proximity to the control circuitry. In other embodiments, the control circuitry might be controlled by a remote or with a touch pad disposed on the hollow housing 105. Still in other embodiments, the control circuitry may be controlled by any means known in the art.

Finally, as illustrated in the preferred embodiment of FIG. 8, is flashlight button 148, which is used to turn the flashlight 180 (not shown) on or off. However, in other embodiments, the flashlight might be turned on or off using some other type of control. Such embodiments might include a sliding switch. Furthermore, in other embodiments, the control circuitry 145 may include controls so that the flashlight 180 can have different cycles of illumination.

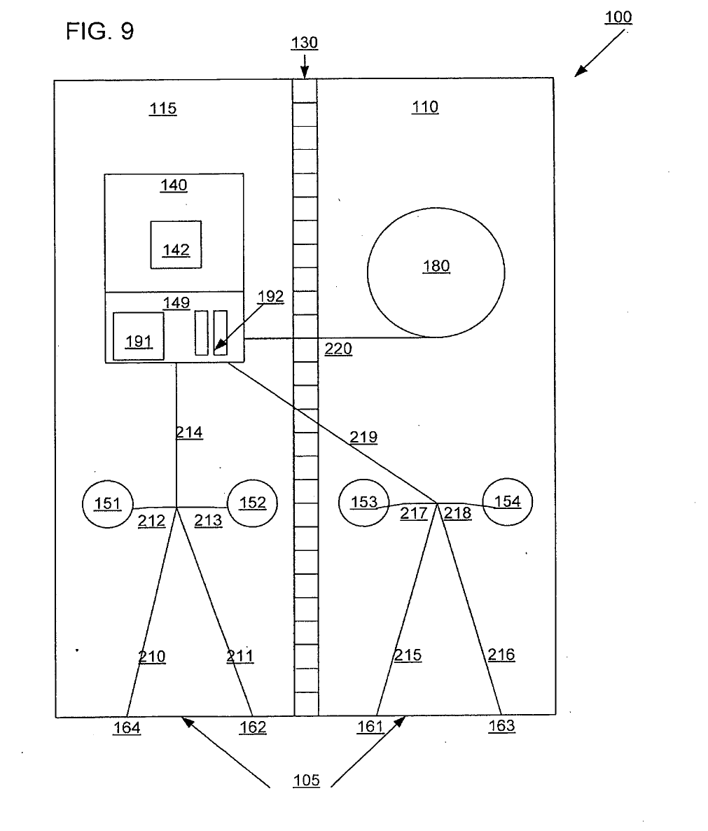

FIG. 9 illustrates an example of the inside electrical connections of the adjustable safety light attachment, according to one embodiment. As illustrated in FIG. 9, a number of wires 210-220 are used to connect lights 151-154, lights 161-164, and flashlight 180 to the circuit board 149. As such, by using the control circuitry 145, a user of the adjustable safety light attachment 100 can control the cycles of illumination and lighting colors for the lights and the flashlight. However, the embodiment of FIG. 9 is not limiting. In other embodiments, any number of wires might be used to electrically connect the lights and the flashlight to the circuit board.

Further illustrated in FIG. 9 is power source 142 included inside of the power source housing 140. As stated above, the power source 142 may be a battery or a plurality of batteries. Furthermore, the power source 142 can be toggled on and off according to the present cycle of illumination selected by the user.

FIG. 9 also illustrates that circuit board 149 is disposed behind the control circuitry 145 within the hollow housing 105. The circuit board 149 may include at least one integrated circuit (I/C) chip 191 and a grouping of resistors 192, as known in the art. Furthermore, as stated above, the circuit board 149 includes the control circuitry 145, which is used to control the cycles of illumination and the colors of the plurality of lights, along with the flashlight 180. When power flows from the power source disposed in the power source casing 140 through the circuit board 149, the lights are illuminated according to the cycles of illumination, discussed above, within the at least one IC chip. The various cycles of illumination are programmed into the IC chip to give the variety of options discussed above. However, the described control circuitry is for the preferred purposes only and is not intended to limit the construction of the adjustable safety light attachment 100 to this specific electrical configuration. One of ordinary skill in the art would be able to adapt other configurations for the circuit board.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. An adjustable safety light attachment, comprising:
a hollow housing having a front portion and a back portion;
a hinge attaching a first side of the front portion to a first side of the back portion, wherein the front portion can swivel with respect to the back portion;
at least one strap attaching a second side of the front portion to a second side of the back portion;
at least one adjustable insert received within the hollow housing to adjust an opening of the hollow housing;
a circuit board having control circuitry and a power source disposed on the hollow housing;
a plurality of lights disposed on the hollow housing and electrically connected to the circuit board;

2. The adjustable safety light attachment of claim 1, further comprising a flashlight disposed on the hollow housing and electrically connected to the circuit board.

3. The adjustable safety light attachment of claim 1, wherein the plurality of lights disposed on the hollow housing comprise LED lights.

4. The adjustable safety light attachment of claim 1, wherein the at least one strap comprise at least one Velcro strap.

5. The adjustable safety light attachment of claim 1, wherein the control circuitry includes a present cycle of illumination patterns for the plurality of lights.

6. The adjustable safety light attachment of claim 1, further comprising a power source outlet disposed on the hollow housing, wherein the power source is recharged using the power source outlet.

7. The adjustable safety light attachment of claim 1, wherein the at least one adjustable insert adjusts the opening of the hollow housing to comprise a circular opening.

8. The adjustable safety light attachment of claim 1, wherein the at least one adjustable insert adjusts the opening of the hollow housing to comprise a circular opening.

9. The adjustable safety light attachment of claim 1, where the plurality of lights comprise at least one of red lights, white lights, and yellow lights.

10. The adjustable safety light attachment of claim 5, wherein the present cycle of illumination patterns includes at least one of a solid display cycle and a flashing display cycle.

11. An adjustable safety light attachment, comprising:
a hollow housing having a front portion and a back portion;
a hinge attaching a first side of the front portion to a first side of the back portion, wherein the front portion can swivel with respect to the back portion;
at least one strap attaching a second side of the front portion to a second side of the back portion;
at least one adjustable insert received within the hollow housing to adjust an opening of the hollow housing;
a circuit board having control circuitry and a power source disposed on the hollow housing;
a flashlight disposed on the hollow housing and electrically connected to the circuit board;
a plurality of lights disposed on the hollow housing and electrically connected to the circuit board;

12. The adjustable safety light attachment of claim 11, wherein an angle of the flashlight can be adjusted to provide light to an environment being worked on.

13. The adjustable safety light attachment of claim 11, wherein the plurality of lights disposed on the hollow housing comprise LED lights.

14. The adjustable safety light attachment of claim 11, wherein the at least one strap comprise at least one Velcro strap.

15. The adjustable safety light attachment of claim 11, wherein the control circuitry includes a present cycle of illumination patterns for the plurality of lights.

16. The adjustable safety light attachment of claim 11, further comprising a power source outlet disposed on the hollow housing, wherein the power source is recharged using the power source outlet.

17. The adjustable safety light attachment of claim 11, wherein the at least one adjustable insert adjusts the opening of the hollow housing to comprise a circular opening.

18. The adjustable safety light attachment of claim 11, wherein the at least one adjustable insert adjusts the opening of the hollow housing to comprise a square opening.

19. The adjustable safety light attachment of claim 11, where the plurality of lights comprise at least one of red lights, white lights, and yellow lights.

20. The adjustable safety light attachment of claim 15, wherein the present cycle of illumination patterns includes at least one of a solid display cycle and a flashing display cycle.
